(19) United States
(12) Patent Application Publication
(10) Pub. No.: US 2025/0253359 A1
(43) Pub. Date: Aug. 7, 2025

(54) FUEL CELL EXHAUST GAS SYSTEM

(71) Applicant: Purem GmbH, Neunkirchen (DE)

(72) Inventors: Tobias Lehr, Esslingen (DE); Gerd Gaiser, Reutlingen (DE)

(21) Appl. No.: 19/047,394

(22) Filed: Feb. 6, 2025

(30) Foreign Application Priority Data
Feb. 6, 2024 (DE) 10 2024 103 210.3

(51) Int. Cl. H01M 8/04014; H01M 8/04119; H01M 8/04746

(52) U.S. Cl. CPC H01M 8/04014; H01M 8/04156; H01M 8/04761; H01M 2250/20

(57) ABSTRACT

A fuel cell exhaust gas system includes a heat exchanger which can be flowed through by fuel cell exhaust gas, and has first and second heat exchanger end regions. The heat exchanger has a fuel cell exhaust gas inlet region in one heat exchanger end region and a fuel cell exhaust gas outlet region in one heat exchanger end region and includes a first heat exchanger flow volume, leading away from the fuel cell exhaust gas inlet region in the heat exchanger longitudinal direction, and a second heat exchanger flow volume, leading back in the direction of the fuel cell exhaust gas inlet region in the heat exchanger longitudinal direction, the first heat exchanger flow volume being separated from a cooling medium flow volume by a first heat exchanger wall and being separated from the second heat exchanger flow volume by a second heat exchanger wall.

### CROSS-REFERENCE TO RELATED APPLICATIONS

This application claims priority of German patent application no. 10 2024 103 210.3, filed Feb. 6, 2024, the entire content of which is incorporated herein by reference.

### TECHNICAL FIELD

The present disclosure relates to a fuel cell exhaust gas system which is preferably configured to output fuel cell exhaust gas which is emitted by a fuel cell in a vehicle, in particular a utility vehicle, to the surroundings.

### BACKGROUND

The exhaust gas stream which is output by a fuel cell and, in particular, also contains the cathode off-gas is enriched with product water which accrues in the region of the cathode of a fuel cell during fuel cell operation. The temperature of the fuel cell exhaust gas which leaves a fuel cell can lie in a range between 50° C. and 100° C., and the relative humidity can lie in a range between 80% and 100%. As a result of the cooling of the fuel cell exhaust gas, for example when it is output into comparatively cold ambient air, the relative humidity rises sharply, with the result that water which is contained as water vapor in the fuel cell exhaust gas condenses with the formation of mist.

Exhaust gas systems are frequently installed in utility vehicles in such a way that they or a substantial part thereof extend substantially vertically upward behind or to the side of a driver's cab, with the result that exhaust gas which is emitted from an exhaust gas system exits to the surroundings in the vertical direction in the upper region of a driver's cab. Here, the substantially vertically extending part of the exhaust gas system is flowed around by the ambient air during driving operation. If fuel cell exhaust gas is intended to be output to the surroundings via an exhaust gas system of this type, condensation of water and therefore a formation of mist can already occur in the interior of the exhaust gas system, above all, at a comparatively low temperature of the ambient air. Although there is the possibility of discharging a part of the condensed water in liquid form, a considerable part of the condensed water is output as mist to the surroundings.

### SUMMARY

It is an object of the present disclosure to provide a fuel cell exhaust gas system, in particular for utility vehicles, in which the extent of the formation of mist in the fuel cell exhaust gas system or during the exit of fuel cell exhaust gas from the fuel cell exhaust gas system is reduced considerably.

According to the disclosure, this object is achieved by a fuel cell exhaust gas system, in particular for utility vehicles, including a heat exchanger which is elongate in a heat exchanger longitudinal direction, can be flowed through by fuel cell exhaust gas, and has a first heat exchanger end region and a second heat exchanger end region, the heat exchanger having a fuel cell exhaust gas inlet region in one heat exchanger end region of the first heat exchanger end region and the second heat exchanger end region and a fuel cell exhaust gas outlet region in one heat exchanger end region of the first heat exchanger end region and the second heat exchanger end region, the heat exchanger including a first heat exchanger flow volume, leading away from the fuel cell exhaust gas inlet region in the heat exchanger longitudinal direction, and a second heat exchanger flow volume, adjoining the first heat exchanger flow volume, leading back in the direction of the fuel cell exhaust gas inlet region in the heat exchanger longitudinal direction, the first heat exchanger flow volume being separated from a cooling medium flow volume by a first heat exchanger wall and being separated from the second heat exchanger flow volume by a second heat exchanger wall.

The thermal interaction of the fuel cell exhaust gas with a cooling medium, for example ambient air which flows around the heat exchanger, in the first heat exchanger flow volume and the cooling which occurs of the fuel cell exhaust gas ensures actively that, in the first heat exchanger flow volume, the relative humidity of the fuel cell exhaust gas increases sharply and reaches a value of 100%. A considerable part of the water entrained in the fuel cell exhaust gas in the form of water vapor can therefore be condensed in the first heat exchanger flow volume and can thus be separated from the fuel cell exhaust gas. The fuel cell exhaust gas which has had water separated from it and enters from the first heat exchanger flow volume into the second heat exchanger flow volume is heated via the thermal interaction, taking place via the first heat exchanger wall, with the fuel cell exhaust gas which flows in the first heat exchanger flow volume, as a result of which the relative humidity of the fuel cell exhaust gas in the second heat exchanger flow volume decreases. In the case of the fuel cell exhaust gas which has had water removed from it, is output via the fuel cell outlet region to the surroundings, and has a comparatively low relative humidity, there is substantially no risk of the formation of mist even at a comparatively low ambient temperature.

If the first heat exchanger flow volume preferably substantially concentrically surrounds the second heat exchanger flow volume with regard to a heat exchanger center axis which runs substantially in the heat exchanger longitudinal direction, a comparatively great surface area is provided for the thermal interaction of the fuel cell exhaust gas with a cooling medium via the first heat exchanger wall, while the second heat exchanger flow volume is substantially shielded to the outside or toward the cooling medium by the first heat exchanger flow volume which surrounds it.

In an alternative refinement, the first heat exchanger flow volume and the second heat exchanger flow volume can be arranged so as to lie next to one another in a layered arrangement transversely with respect to the heat exchanger longitudinal direction. If the second heat exchanger flow volume is arranged transversely with respect to the heat exchanger longitudinal direction between a first part of the first heat exchanger flow volume and a second part of the first heat exchanger flow volume, a comparatively great surface area is once again provided for the thermal interaction between the fuel cell exhaust gas flowing in the first heat exchanger flow volume and the cooling medium, while the fuel cell exhaust gas which has had water removed and flows in the second heat exchanger flow volume is shielded efficiently by the first heat exchanger flow volume against thermal interaction with the cooling medium.

It can be provided in the case of a compact configuration that the heat exchanger inlet region and the heat exchanger outlet region are provided on the first heat exchanger end region, and that the heat exchanger outlet region adjoins the second heat exchanger flow volume.

For a linear embodiment of a fuel cell exhaust gas system which is advantageous, in particular, for installation in utility vehicles, it is proposed that a third heat exchanger flow volume is provided which adjoins the second heat exchanger flow volume and leads away in the direction from the heat exchanger inlet region, the third heat exchanger flow volume being separated from the second heat exchanger flow volume by a third heat exchanger wall.

In order to also efficiently shield the fuel cell exhaust gas which flows in the third heat exchanger flow volume against thermal interaction with the cooling medium, the second heat exchanger flow volume can preferably substantially concentrically surround the third heat exchanger flow volume with regard to the heat exchanger center axis.

In the case of a linear embodiment of a fuel cell exhaust gas system of this type, the heat exchanger inlet region can be provided on the first heat exchanger end region, the heat exchanger outlet region can be provided on the second heat exchanger end region, and the heat exchanger outlet region can adjoin the third heat exchanger flow volume.

In order for it to be possible for flow resistances to be avoided or reduced which are introduced unavoidably by the heat exchanger when there is substantially no risk of a formation of mist even in the case of a high water content in the fuel cell exhaust gas, for example on account of a sufficiently high ambient temperature, it is proposed that a bypass flow path is provided which leads from the first heat exchanger flow volume or the heat exchanger inlet region to the heat exchanger outlet region and can selectively be opened or shut off for throughflow.

In particular in the case of an embodiment of the heat exchanger with three heat exchanger flow volumes which follow one another or adjoin one another in the flow direction, at least one bypass flow opening which can be opened or shut off for throughflow selectively by a shut-off arrangement can be provided in the region of the second heat exchanger wall, for the provision of such a bypass flow path.

If the at least one bypass flow opening is arranged on the second heat exchanger end region, substantially the entire second heat exchanger flow volume and third heat exchanger flow volume are not flowed through by the fuel cell exhaust gas in the case of a released bypass flow path, as a result of which a significant reduction in the flow resistance introduced by the heat exchanger is achieved.

For an efficient thermal interaction between the fuel cell exhaust gas which flows in the first heat exchanger flow volume and the cooling medium, a plurality of first heat transfer fins can be provided on an outer side, facing the cooling medium flow volume, of the first heat exchanger wall.

In order to achieve a low flow resistance for the cooling medium, that is, for example, the ambient air which flows around the fuel cell exhaust gas system in the driving state of a vehicle, the first heat transfer fins can extend substantially orthogonally with respect to the heat exchanger longitudinal direction. This means that the great surface areas, provided for thermal interaction with the cooling medium, of the first heat transfer fins are oriented substantially parallel to the flow direction of the cooling medium.

For an efficient thermal interaction of the cooling medium with the fuel cell exhaust gas which flows in the first heat exchanger flow volume, furthermore, a plurality of second heat transfer fins can be provided on an inner side, facing the first heat exchanger flow volume, of the first heat exchanger wall.

In order to also achieve as low a flow resistance as possible for the fuel cell exhaust gas, the second heat transfer fins can extend substantially parallel to the heat exchanger longitudinal direction. Here too, the great surface areas, provided for thermal interaction, of the second heat transfer fins are therefore oriented in such a way that they lie parallel to the flow direction or main flow direction of the fuel cell exhaust gas in the first heat exchanger flow volume.

The separation of water entrained in the fuel cell exhaust gas in droplet form in the first heat exchanger flow volume can be assisted by the fact that the heat exchanger inlet region is configured in such a way that fuel cell exhaust gas enters into the first heat exchanger flow volume on the heat exchanger inlet region with a fuel cell exhaust gas inlet flow direction which is oriented tangentially with regard to the heat exchanger center axis. As a result, the fuel cell exhaust gas is forced into a circular or a helical flow path, with the result that water droplets entrained in the fuel cell exhaust gas are loaded radially to the outside under the action of centrifugal force, collect on the inner surface of the first heat exchanger wall, and can be discharged from there.

For this purpose, a liquid discharge device can be provided for discharging liquid from the heat exchanger. This can include an opening in the heat exchanger inlet region, for example that opening, via which the fuel cell exhaust gas also enters on the heat exchanger inlet region into the first heat exchanger flow volume.

It is advantageous, in particular, for use in conjunction with utility vehicles if the fuel cell exhaust gas system is configured for installation with a substantially vertically oriented heat exchanger longitudinal direction, with the result that the first heat exchanger end region forms a lower heat exchanger end region, and the second heat exchanger end region forms an upper heat exchanger end region.

Furthermore, the disclosure relates to a vehicle, in particular a utility vehicle, including a fuel cell exhaust gas system which is constructed according to the disclosure.

The fuel cell exhaust gas system advantageously is installed into the vehicle in such a way that the first heat exchanger end region is positioned at the bottom in a vertical direction, and the second heat exchanger end region is positioned at the top in the vertical direction. As a result, in particular, the possibility is also created that the heat exchanger is flowed around by ambient air which surrounds the vehicle as cooling medium.

### BRIEF DESCRIPTION OF DRAWINGS

The invention will now be described with reference to the drawings wherein:

FIG. 1 shows an outline illustration of a vehicle, configured as a utility vehicle, with a fuel cell and a fuel cell exhaust gas system;

FIG. 2 shows a longitudinal sectional view of a heat exchanger for the fuel cell exhaust gas system shown in FIG. 1;

FIG. 3 shows a side view of a heat exchanger for the fuel cell exhaust gas system shown in FIG. 1;

FIG. 4 shows a cross-sectional view of the heat exchanger of FIG. 3;

FIG. 5 shows a diagram which illustrates the development of the temperature of the fuel cell exhaust gas which flows through the heat exchanger of FIG. 2;

FIG. 6 shows a diagram which illustrates the development of the relative humidity of the fuel cell exhaust gas which flows through the heat exchanger of FIG. 2;

FIG. 7 shows an illustration (corresponding to FIG. 2) of a heat exchanger with an alternative embodiment of a heat exchanger inlet region;

FIG. 8 shows a cross-sectional illustration of the heat exchanger from FIG. 7;

FIG. 9 shows a further illustration (corresponding to FIG. 2) of a heat exchanger with an alternative embodiment;

FIG. 10 shows a further illustration (corresponding to FIG. 2) of a heat exchanger with an alternative embodiment;

FIG. 11 shows a further illustration (corresponding to FIG. 2) of a heat exchanger with an alternative embodiment; and,

FIG. 12 shows a perspective view of the heat exchanger from FIG. 11.

### DETAILED DESCRIPTION

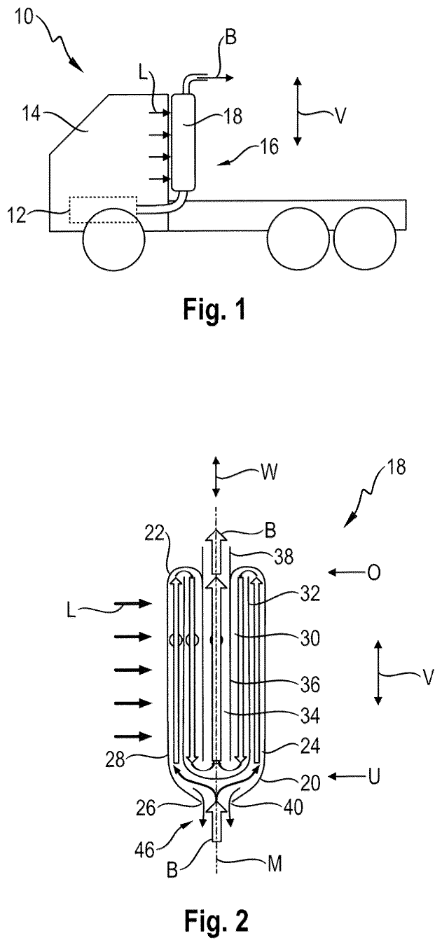

In FIG. 1, a vehicle which is configured as a utility vehicle is denoted overall by 10. The vehicle 10 which is, for example, driven electrically includes a fuel cell 12 as a source of electrical energy, by which traction motors (not shown) of the vehicle 10 are supplied with electrical energy. The fuel cell exhaust gas B which is generated by the fuel cell 12 is output to the surroundings via a fuel cell exhaust gas system 16 in a region behind or to the side of the driver's cab 14 which extends upward in a vertical direction V.

As an essential constituent part, the fuel cell exhaust gas system 16 includes a heat exchanger 18 (described in detail in the following text) which, in particular in the driving state of the vehicle 10, is flowed around by ambient air L which provides a cooling medium, as a result of which heat is transferred from the fuel cell exhaust gas B which flows through the heat exchanger 18 to the ambient air L and the fuel cell exhaust gas B is cooled.

FIG. 2 shows a longitudinal section of the heat exchanger 18 which is elongate in a heat exchanger longitudinal direction W along a heat exchanger center axis M. The heat exchanger 18 has a first heat exchanger end region 20 which is positioned at the bottom in the case of the substantially vertical installation illustrated in FIG. 1. The first heat exchanger end region 20 therefore forms a lower heat exchanger region. Furthermore, the heat exchanger 18 has a second heat exchanger end region 22 which provides an upper heat exchanger end region in the case of the vertical installation.

The heat exchanger 18 which is shown in FIG. 2 has three heat exchanger flow volumes which are arranged concentrically with respect to one another with regard to the heat exchanger center axis M. A first heat exchanger flow volume 24 leads from a heat exchanger inlet region 26, configured on the first heat exchanger end region 20, to the second heat exchanger end region 22. The first heat exchanger flow volume 24 is bordered radially on the outside by a first heat exchanger wall 28, with the result that the fuel cell exhaust gas which flows in the first heat exchanger flow volume 24 substantially in a fuel cell exhaust gas main flow direction which corresponds to the heat exchanger longitudinal direction W is separated by the first heat exchanger wall 28 from the ambient air L which acts as cooling medium. Here, the surroundings around the heat exchanger 18 form a cooling medium flow volume for the cooling medium of ambient air which flows around the heat exchanger 18 on its outer side.

A second heat exchanger flow volume 30 is provided so as to directly follow the first heat exchanger flow volume radially on the inside, which second heat exchanger flow volume 30 adjoins the first heat exchanger flow volume 24 in the second heat exchanger end region 22 and leads back from the second heat exchanger end region 22 in the direction of the first heat exchanger end region 20. The second heat exchanger flow volume 30 is separated from the first heat exchanger flow volume 24 radially to the outside by a second heat exchanger wall 32. In the second heat exchanger flow volume 30, the fuel cell exhaust gas B flows with a fuel cell exhaust gas main flow direction which is oriented substantially in the direction of the heat exchanger longitudinal direction W and is substantially opposed to the fuel cell exhaust gas main flow direction in the first heat exchanger flow volume 24.

A third heat exchanger flow volume 34 is provided radially within the second heat exchanger flow volume 30, which third heat exchanger flow volume 34 is separated radially to the outside with respect to the second heat exchanger flow volume 30 by a third heat exchanger wall 36. In the third heat exchanger flow volume 34 which adjoins the second heat exchanger flow volume 30 in the first heat exchanger end region 20, the fuel cell exhaust gas B flows substantially in a fuel cell exhaust gas main flow direction which is oriented in the direction of the heat exchanger longitudinal direction W, also corresponds substantially to the fuel cell exhaust gas main flow direction in the first heat exchanger flow volume 24, and is oriented in an opposed manner with respect to the fuel cell exhaust gas main flow direction in the second heat exchanger flow volume 30.

It is to be noted in this context that the flow direction components are considered in each case as main flow directions in the different heat exchanger flow volumes 24, 30, 34, which flow direction components ensure that the fuel cell exhaust gas B moves from one of the heat exchanger end regions to the other heat exchanger end region. As will still be explained in the following text, this does not rule out it being possible for there to be flow direction components which are oriented, for example, in the peripheral direction and differ locally from such a main flow direction which is oriented in the direction of the heat exchanger longitudinal direction W.

The third heat exchanger flow volume 34 is adjoined by a heat exchanger outlet region 38 which is positioned in the second heat exchanger end region 22 and via which, as is illustrated in FIG. 1, the fuel cell exhaust gas B can be output to the surroundings, for example via a curved pipe portion.

In the case of that construction of the heat exchanger 18 which is shown in FIG. 2, the centrally positioned third heat exchanger flow volume 34 is shielded radially to the outside and therefore with respect to the ambient air L substantially by the second and first heat exchanger flow volumes 30, 24 which are positioned radially outside it. The second heat exchanger flow volume 30 which encloses the centrally positioned third heat exchanger flow volume 34 in the form of an annular space is shielded radially to the outside and therefore with respect to the ambient air L by the first heat exchanger flow volume 24 which is likewise configured as an annular space.

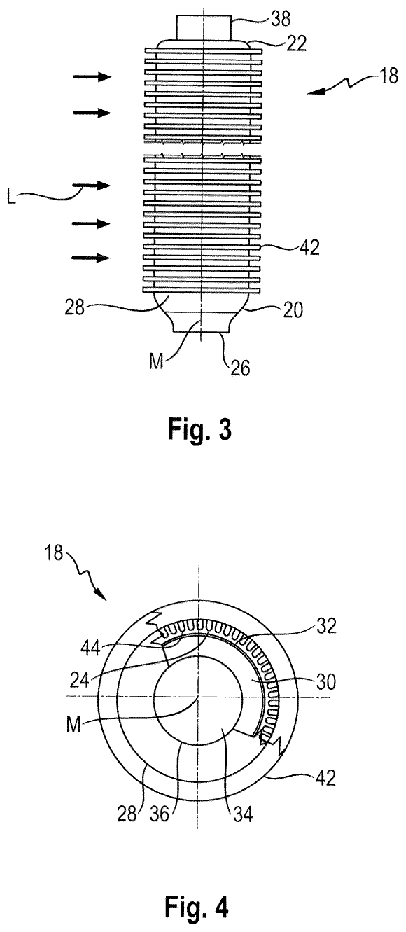

The fuel cell exhaust gas B which flows in the first heat exchanger flow volume 24, enters on the heat exchange inlet region 26, for example via an inlet opening 40 which is provided there, substantially in the heat exchanger longitudinal direction W into the heat exchanger 18 or the first heat exchanger flow volume 24, and is at a comparatively high temperature is in thermal interaction via the first heat exchanger wall 28 with the ambient air L which acts as cooling medium. As illustrated in FIG. 3, a plurality of first heat transfer fins 42 can be arranged so as to follow one another in the direction of the heat exchanger center axis M on that outer side of the first heat exchanger wall 28 which faces the ambient air L, for efficient thermal interaction. For an efficient thermal interaction with the ambient air L, the first heat transfer fins 42 are oriented substantially orthogonally with respect to the heat exchanger center axis M, with the result that the great surfaces, oriented in each case in the direction of the heat exchanger center axis M, of the heat transfer fins 42 are oriented substantially parallel to the flow direction of the ambient air L.

In order to improve the thermal interaction between the fuel cell exhaust gas B and the ambient air L, a plurality of second heat transfer fins 44 can be provided so as to follow one another in the peripheral direction and so as to extend substantially in the direction of the heat exchanger center axis M on that inner side of the first heat exchanger wall 28 which faces the first heat exchanger flow volume 24. The substantially radially oriented great heat transfer surfaces of the second heat transfer fins 44 therefore extend substantially in the direction of the heat exchanger center axis M and therefore also substantially in the direction of the fuel cell exhaust gas main flow direction in the first heat exchanger flow volume 24.

It is to be noted that the structure, nested inside one another or surrounding each other mutually, of the heat exchanger flow volumes can be realized even in the case of a non-circular embodiment of the latter. For example, they can have cross sections with flattened roundness or polygonal cross sections.

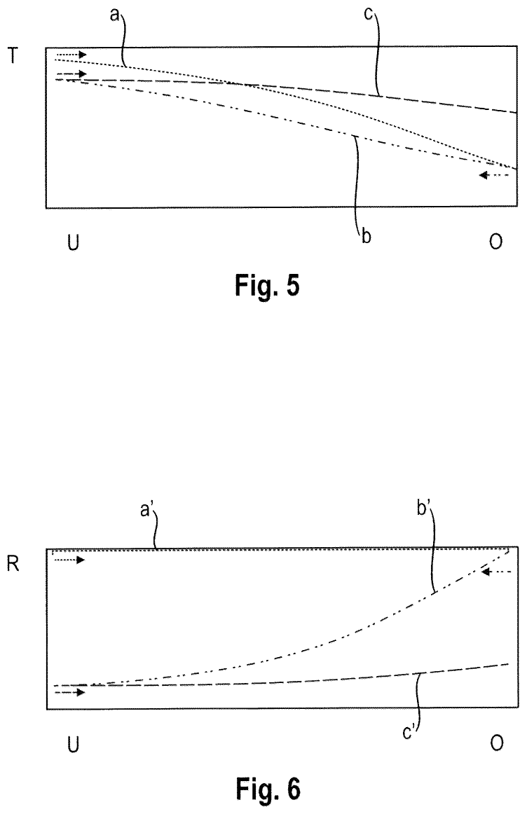

When flowing through the first heat exchanger flow volume 24, the fuel cell exhaust gas B outputs heat to the ambient air L, above all, at a comparatively low temperature of the ambient air L, and is cooled in the process. Therefore, during the throughflow of the first heat exchanger flow volume 24 from the first heat exchanger end region 20, that is, a position U, in the direction of the second heat exchanger end region 22, that is, a position O, the temperature T of the fuel cell exhaust gas B decreases, as illustrated by a branch a in the temperature-displacement diagram of FIG. 5. Accordingly, as illustrated by a branch a′ in the relative humidity-displacement diagram of FIG. 6, the relative humidity R of the fuel cell exhaust gas B increases or remains at 100%. As a result of the cooling of the fuel cell exhaust gas B, water entrained in the fuel cell exhaust gas B in the form of water vapor is condensed and will be deposited on the inner surface of the first heat exchanger wall 28 and, if present, the surfaces of the second heat transfer fins 44. Due to gravity, the water which accumulates on these surfaces can then flow out downward and can be discharged in the region of a liquid discharge device 46 which includes, for example, the inlet opening 40 of the fuel cell inlet region 26, for example to a collecting vessel which is positioned below the heat exchanger 18.

The fuel cell exhaust gas B which is cooled and has had water removed leaves the first heat exchanger flow volume 24 on the second fuel cell end region 22, that is, at the position O, and enters into the second heat exchanger flow volume 30. Since this is shielded by the first heat exchanger flow volume 24 outside toward the ambient air L, the temperature T of the fuel cell exhaust gas B no longer decreases when flowing through the second heat exchanger flow volume 30. Rather, a thermal interaction between the fuel cell exhaust gas B in the second heat exchanger flow volume 30 and the fuel cell exhaust gas B in the first heat exchanger flow volume 24 arises as a result of the counterflow which is generated in the first heat exchanger flow volume 24 with regard to the fuel cell exhaust gas flow, with the result that, as illustrated by a branch b in FIG. 5, the temperature T of the fuel cell exhaust gas B increases again and its relative humidity R therefore decreases, as illustrated by a branch b′ in FIG. 6.

At the lower end of the second heat exchanger flow volume 30, the fuel cell exhaust gas B which has had water removed enters with a lower relative humidity R into the third heat exchanger flow volume 34 and flows through the latter in the direction of the heat exchanger outlet region 38. Here, as illustrated using a branch c in FIG. 5, the temperature T of the fuel cell exhaust gas B can decrease slightly again, while at the same time, as illustrated by a branch c′ in FIG. 6, the relative humidity R of the fuel cell exhaust gas B can rise slightly.

As illustrated using FIGS. 5 and 6, the temperature T of the fuel cell exhaust gas B decreases when flowing through the heat exchanger 18 on account of the thermal interaction with the ambient air L which is active as cooling medium, while the relative humidity R of the fuel cell exhaust gas B also decreases on account of condensation of water, in particular, in the first heat exchanger flow volume 24. The fuel cell exhaust gas B which has had water removed in this way then passes into the surroundings with a considerably reduced relative humidity, with the result that, when the fuel cell exhaust gas B which is output to the outside is cooled considerably upon contact with the ambient air L, the risk that the relative humidity R of the fuel cell exhaust gas B rises spontaneously to a value at 100% is decreased considerably even in the case of a comparatively low temperature of the ambient air L. Accordingly, the risk that a formation of mist occurs at the outlet region of the fuel cell exhaust gas system 16, above all at a comparatively low ambient temperature, is also decreased considerably.

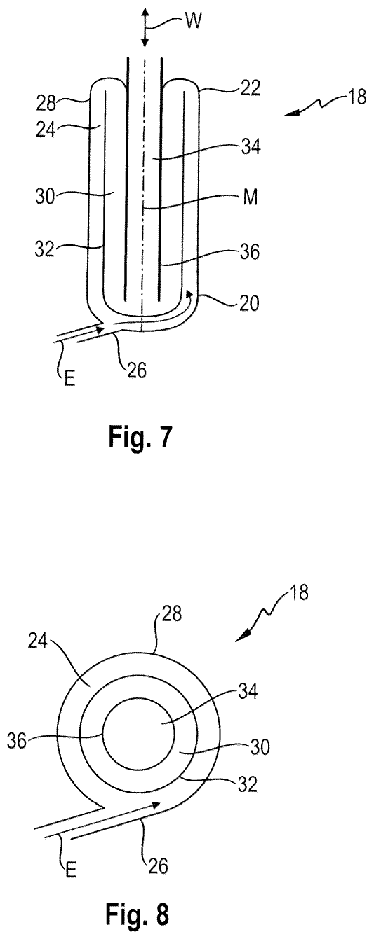

FIGS. 7 and 8 show a modification of the heat exchanger 18 which is shown in FIG. 2. In the case of this heat exchanger 18, the heat exchanger inlet region is configured in such a way that the fuel cell exhaust gas enters into the heat exchanger 18 or the first heat exchanger flow volume 24 with a fuel cell exhaust gas inlet flow direction E which is oriented tangentially with regard to the heat exchanger center axis M. The fuel cell exhaust gas B therefore flows substantially in the peripheral direction into the first heat exchanger flow volume 24. On account of the centrifugal force which occurs in the process, water droplets contained in the fuel cell exhaust gas B are loaded radially to the outside against the inner surface of the first heat exchanger wall 28, with the result that water components which are entrained in the fuel cell exhaust gas B in droplet form and enter into the heat exchanger 18 can be separated from the fuel cell exhaust gas B and, as described above, can be discharged downward or in the direction of a water reservoir or the like by a liquid discharge device 46 which is configured, for example, in the region of the fuel cell inlet region 26.

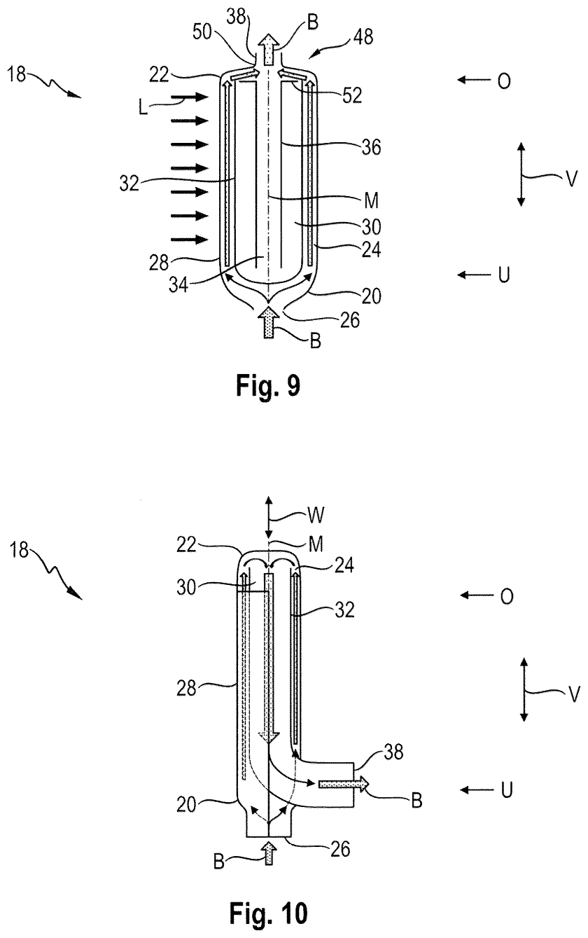

A further modification of the heat exchanger 18 which is shown in FIG. 2 is illustrated in FIG. 9. In the case of the heat exchanger 18 of FIG. 9, a bypass flow path which is denoted generally by 48 is formed on the second heat exchanger end region 22, that is, in the region of the downstream end of the first heat exchanger flow volume 24. In the embodiment which is shown, the bypass flow path 48 includes, in the third heat exchanger wall 38, one or more bypass flow openings 50 which can be released or shut off selectively for throughflow by an associated shut-off arrangement 52. For example, each shut-off arrangement 52 which is assigned to a bypass flow opening 50 can include an associated adjustable flap, a slide, a poppet valve or the like. For example, these shut-off arrangements 52 can be provided in such a way that, when they are moved into a position which releases the associated bypass flow opening 50 for throughflow, they substantially shut off the second heat exchanger flow volume 30 in its downstream end region against the entry of fuel cell exhaust gas B.

A flow connection from the downstream end of the first heat exchanger flow volume 24 directly into the heat exchanger outlet region 38 is provided by the bypass flow path 48, with the result that the fuel cell exhaust gas B which flows through the heat exchanger 18 flows through only the first heat exchanger flow volume 24, but not the second heat exchanger flow volume 30 and the third heat exchanger flow volume 34. This state can be selected if there is no risk of condensation of water from the fuel cell exhaust gas B during the exit of the fuel cell exhaust gas B to the surroundings on account of the thermal conditions. The flow resistance which occurs in the heat exchanger 18 is lowered considerably by the release of the bypass flow path 48, since the second heat exchanger flow volume 30 and the third heat exchanger flow volume 34 are not flowed through. Nevertheless, water which possibly condenses in the first heat exchanger flow volume 34 and collects there can be discharged in the way described above in relation to the embodiment of FIG. 2 from the heat exchanger 18 via the liquid discharge device 46.

A further modification of the heat exchanger 18 is shown in FIG. 10. In the case of the heat exchanger 18 which is shown in FIG. 10, the first heat exchanger flow volume 24 and the second heat exchanger flow volume 30 are arranged coaxially with respect to one another or with respect to the heat exchanger center axis M. The heat exchanger 18 of FIG. 10 does not have, however, a third heat exchanger flow volume. The heat exchanger outlet region 38 is positioned on the first heat exchanger end region 20 just like the heat exchanger inlet region 26. The fuel cell exhaust gas B therefore leaves the heat exchanger 18 after the thermal interaction, generated via the second heat exchanger wall 32, with the fuel cell exhaust gas B which flows in the first heat exchanger flow volume 24 and is cooled by the ambient air L. When FIGS. 5 and 6 are considered, this means that the respective last branch c or c′ is missing, and the fuel cell exhaust gas B exits from the heat exchanger 18 at the temperature T and/or the relative humidity R which is present in each case at the end of the branch b or b′ at the position U.

The heat exchanger 18 of FIG. 10 can also be integrated into a vehicle in such a way that its heat exchanger center axis M is oriented substantially vertically, for example as shown in FIG. 1, to the side of or behind the driver's cab 14. The fuel cell exhaust gas B can then be emitted to the surroundings in a lower region of the vehicle 10

It is to be noted that a bypass flow path can also be present in the case of that configuration variant of the heat exchanger 18 which is shown in FIG. 10, which bypass flow path then leads directly from the heat exchanger inlet region 26 to the heat exchanger outlet region 38, with the result that, when this is not required for thermal reasons, a throughflow of the first heat exchanger flow volume 24 and the second heat exchanger flow volume 30 does not take place.

In the case of an embodiment of this type, in which, as has been shown in FIG. 9 and has been described above in relation to FIG. 10, a bypass flow path can selectively be released or shut off, it can preferably be provided that the shut-off arrangement which is used for this purpose is actuated in such a way that the quantity of the fuel cell exhaust gas B which is discharged via the bypass flow path is selected in such a way that a formation of mist at the outlet of the fuel cell exhaust gas system 16 is prevented. For this purpose, different parameters such as, for example, the temperature of the ambient air L, the air humidity of the ambient air L, the temperature of the fuel cell exhaust gas B and/or also the relative humidity of the fuel cell exhaust gas B can be taken into consideration.

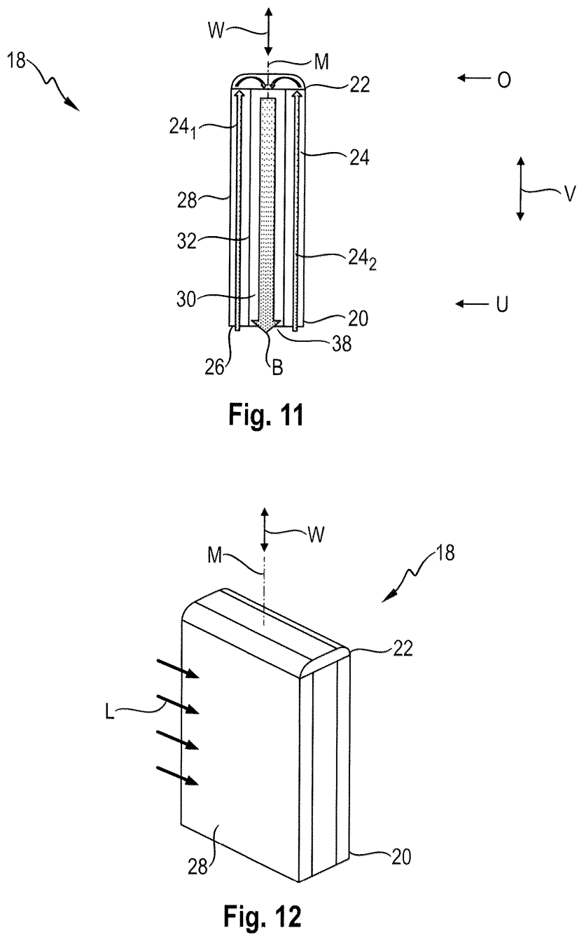

A further modification of the heat exchanger 18 is shown in FIGS. 11 and 12. In the case of this embodiment, the existing heat exchanger flow volumes are not arranged so as to surround each other or concentrically with respect to one another, but rather are arranged next to one another in a layered, substantially planar arrangement laterally next to one another with regard to the heat exchanger longitudinal direction W and the heat exchanger center axis M or a plane which contains the heat exchanger center axis M and is orthogonal with respect to the plane of the drawing of FIG. 1.

The heat exchanger 18 which is shown in FIGS. 11 and 12 also has only the first heat exchanger flow volume 24 and the second heat exchanger flow volume 30. The first heat exchanger flow volume 24 is divided into a first part 241 and a second part 242. The second heat exchanger flow volume 30 is positioned between the first part 241 of the first heat exchanger flow volume 24 and the second part 242 of the first heat exchanger flow volume 24.

It is also the case in this embodiment that the second heat exchanger flow volume 30 is shielded efficiently against thermal interaction with the ambient air Lin the case of a comparatively large interaction surface area between the first heat exchanger flow volume 24 and the surroundings. The heat exchanger 18 of FIGS. 11 and 12 can also be installed into a vehicle 10, in particular the utility vehicle shown in FIG. 1, in such a way that the heat exchanger center axis M is oriented substantially vertically, with the result that the fuel cell exhaust gas B both enters into the heat exchanger 18 in the first heat exchanger end region 20 which lies at the lower position U and also exits from the heat exchanger 18 at the lower position U.

The heat exchanger of FIGS. 10 and 11 can be integrated into the vehicle 10, for example, in such a way that, in order to be flowed around efficiently with the ambient air L, the first heat exchanger wall 28 which delimits the first part 241 and the second part 242 toward the outside, that is, toward the ambient air L, is oriented substantially parallel to the vehicle longitudinal direction and therefore substantially parallel to the flow direction of the ambient air L in the case of a forward movement of the vehicle. In this way, an efficient thermal interaction with the ambient air L can be achieved on the two longitudinal sides of the heat exchanger 18.

Finally, it is to be noted that, as an alternative or in addition to the use of the ambient air L, the fuel cell exhaust gas which flows in the first heat exchanger flow volume can be brought into thermal interaction with another cooling medium which is, for example, liquid. To this end, a flow volume for liquid cooling medium of this type which can circulate in a cooling medium circuit of the vehicle can be provided on the outer side of the first heat exchanger wall 28.

It is understood that the foregoing description is that of the preferred embodiments of the invention and that various changes and modifications may be made thereto without departing from the spirit and scope of the invention as defined in the appended claims.

1. A fuel cell exhaust gas system comprising:
a heat exchanger configured to be elongate in a heat exchanger longitudinal direction and to be flowed through by fuel cell exhaust gas;
said heat exchanger having a first heat exchanger end region and a second heat exchanger end region;
said heat exchanger having a fuel cell exhaust gas inlet region in one heat exchanger end region of said first heat exchanger end region and said second heat exchanger end region and a fuel cell exhaust gas outlet region in one heat exchanger end region of said first heat exchanger end region and said second heat exchanger end region;
said heat exchanger including a first heat exchanger flow volume leading away from said fuel cell exhaust gas inlet region in said heat exchanger longitudinal direction and including a second heat exchanger flow volume adjoining said first heat exchanger flow volume leading back in the direction of the fuel cell exhaust gas inlet region in the heat exchanger longitudinal direction; and,
said first heat exchanger flow volume being separated from a cooling medium flow volume by a first heat exchanger wall and being separated from said second heat exchanger flow volume by a second heat exchanger wall.

2. The fuel cell exhaust gas system of claim 1, wherein said first heat exchanger flow volume concentrically surrounds said second heat exchanger flow volume with respect to a heat exchanger center axis running in the heat exchanger longitudinal direction.

3. The fuel cell exhaust gas system of claim 1, wherein said first heat exchanger flow volume and said second heat exchanger flow volume are arranged so as to lie next to one another in a layered arrangement transversely with respect to said heat exchanger longitudinal direction.

4. The fuel cell exhaust gas system of claim 3, wherein said second heat exchanger flow volume is arranged transversely with respect to said heat exchanger longitudinal direction between a first part of said first heat exchanger flow volume and a second part of said first heat exchanger flow volume.

5. The fuel cell exhaust gas system of claim 2, wherein said heat exchanger inlet region and said heat exchanger outlet region are provided on said first heat exchanger end region and said heat exchanger outlet region adjoins said second heat exchanger flow volume.

6. The fuel cell exhaust gas system of claim 1, wherein a third heat exchanger flow volume is provided which adjoins said second heat exchanger flow volume and leads away in a direction from said heat exchanger inlet region, said third heat exchanger flow volume being separated from said second heat exchanger flow volume by a third heat exchanger wall.

7. The fuel cell exhaust gas system of claim 6, wherein said first heat exchanger flow volume concentrically surrounds said second heat exchanger flow volume with respect to a heat exchanger center axis running in the heat exchanger longitudinal direction; and, said second heat exchanger flow volume concentrically surrounds said third heat exchanger flow volume with respect to said heat exchanger center axis.

8. The fuel cell exhaust gas system of claim 6, wherein said heat exchanger inlet region is provided on said first heat exchanger end region, wherein said heat exchanger outlet region is provided on said second heat exchanger end region, and wherein said heat exchanger outlet region adjoins said third heat exchanger flow volume.

9. The fuel cell exhaust gas system of claim 1, wherein a bypass flow path is provided leading from said first heat exchanger flow volume or said heat exchanger inlet region to the heat exchanger outlet region and can selectively be opened or shut off for throughflow.

10. The fuel cell exhaust gas system of claim 6, wherein at least one bypass flow opening which can be opened or shut off for throughflow selectively by a shut-off arrangement is provided in the region of said second heat exchanger wall.

11. The fuel cell exhaust gas system of claim 10, wherein said at least one bypass flow opening is arranged on the second heat exchanger end region.

12. The fuel cell exhaust gas system of claim 1, wherein a plurality of first heat transfer fins are provided on an outer side, facing said cooling medium flow volume, of said first heat exchanger wall.

13. The fuel cell exhaust gas system of claim 12, wherein said plurality of first heat transfer fins extend orthogonally with respect to said heat exchanger longitudinal direction.

14. The fuel cell exhaust gas system of claim 1, wherein a plurality of second heat transfer fins are provided on an inner side, facing said first heat exchanger flow volume, of said first heat exchanger wall.

15. The fuel cell exhaust gas system of claim 14, wherein said plurality of second heat transfer fins extend parallel to said heat exchanger longitudinal direction.

16. The fuel cell exhaust gas system of claim 2, wherein said heat exchanger inlet region is configured in such a way that fuel cell exhaust gas enters into said first heat exchanger flow volume on said heat exchanger inlet region with a fuel cell exhaust gas inlet flow direction which is oriented tangentially with respect to the heat exchanger center axis.

17. The fuel cell exhaust gas system of claim 1, wherein a liquid discharge device is provided for discharging liquid from said heat exchanger.

18. The fuel cell exhaust gas system of claim 1, wherein said fuel cell exhaust gas system is configured for installation with a vertically oriented heat exchanger longitudinal direction, with the result that the first heat exchanger end region forms a lower heat exchanger end region, and the second heat exchanger end region forms an upper heat exchanger end region.

19. A vehicle, comprising:
a fuel cell exhaust gas system including:
a heat exchanger configured to be elongate in a heat exchanger longitudinal direction and to be flowed through by fuel cell exhaust gas;
said heat exchanger having a first heat exchanger end region and a second heat exchanger end region;
said heat exchanger having a fuel cell exhaust gas inlet region in one heat exchanger end region of said first heat exchanger end region and said second heat exchanger end region and a fuel cell exhaust gas outlet region in one heat exchanger end region of said first heat exchanger end region and said second heat exchanger end region;
said heat exchanger including a first heat exchanger flow volume leading away from said fuel cell exhaust gas inlet region in said heat exchanger longitudinal direction and including a second heat exchanger flow volume adjoining said first heat exchanger flow volume leading back in the direction of the fuel cell exhaust gas inlet region in the heat exchanger longitudinal direction; and,
said first heat exchanger flow volume being separated from a cooling medium flow volume by a first heat exchanger wall and being separated from said second heat exchanger flow volume by a second heat exchanger wall.

20. The vehicle of claim 19, wherein said fuel cell exhaust gas system is configured for installation with a vertically oriented heat exchanger longitudinal direction, with the result that the first heat exchanger end region forms a lower heat exchanger end region, and the second heat exchanger end region forms an upper heat exchanger end region; and, said fuel cell exhaust gas system is installed into the vehicle in such a way that said first heat exchanger end region is positioned at the bottom in a vertical direction, and said second heat exchanger end region is positioned at the top in the vertical direction.

21. The vehicle of claim 19, wherein the fuel cell exhaust gas system is installed in the vehicle in such a way that the heat exchanger can be flowed around by ambient air which surrounds the vehicle as a cooling medium.

22. The vehicle of claim 19, wherein said vehicle is a utility vehicle.
